(19) United States
(12) Patent Application Publication
(10) Pub. No.: US 2025/0114792 A1
(43) Pub. Date: Apr. 10, 2025

(54) HANDLING OF TWO VOLUMES OF LIQUID

(71) Applicant: Hahn-Schickard-Gesellschaft für angewandte Forschung e.V., Villingen-Schwenningen (DE)

(72) Inventors: Tobias HUTZENLAUB, Ettenheim (DE); Nils PAUST, Freiburg (DE); Laura NIEBLING, Freiburg (DE); Jacob HESS, Freiburg (DE); Jan-Niklas KLATT, Freiburg (DE); Judith SCHLANDERER, Freiburg (DE)

(73) Assignee: Hahn-Schickard-Gesellschaft für angewandte Forschung e.V., Villingen-Schwenningen (DE)

(21) Appl. No.: 18/920,798

(22) Filed: Oct. 18, 2024

Related U.S. Application Data
(63) Continuation of application No. PCT/EP2023/058334, filed on Mar. 30, 2023.

(30) Foreign Application Priority Data
Apr. 20, 2022 (DE) 102022203875.4

(51) Int. Cl. B01L 3/00

(52) U.S. Cl. CPC B01L 3/502753; B01L 2300/0829; B01L 2300/0864; B01L 2400/0409

(57) ABSTRACT

A fluidic module for use in a centrifugal microfluidic system includes a fluid chamber with a first chamber region and a second chamber region separated from each other by a partition wall extending radially inwardly with respect to a centre of rotation. A first outlet channel opens into the first chamber region and represents an outflow barrier for a liquid flow from the first chamber region in the form of a radially inwardly rising channel portion which extends to a first radial position. A second outlet channel opens into the second chamber region and represents an outflow barrier for a liquid flow from the second chamber region in the form of a radially inwardly rising channel portion which extends to a second radial position. The first radial position is located radially further inwards than the second radial position, wherein the fluidic module is configured such that, based on a rotation in which a hydrostatic pressure acting on the first and second liquid volumes prevents the liquid volumes from flowing out of the fluid chamber through the first and second outlet channels, a positive pressure in the common air volume required to transfer the first liquid volume out of the fluid chamber through the first outlet channel against the hydrostatic pressure acting on the first liquid volume is greater than a positive pressure in the common air volume required to transfer the second liquid volume out of the fluid chamber through the second outlet channel against the hydrostatic pressure acting on the second liquid volume.

### CROSS-REFERENCES TO RELATED APPLICATIONS

This application is a continuation of copending International Application No. PCT/EP2023/058334, filed Mar. 30, 2023, which is incorporated herein by reference in its entirety, and additionally claims priority from German Applications No. DE 10 2022 203 875.4, filed Apr. 20, 2022, which is incorporated herein by reference in its entirety.

The present invention relates to fluidic modules, devices and methods for handling two liquid volumes and, in particular, to fluidic modules, devices and methods suitable for receiving two liquid volumes in a fluid chamber and transferring them out of the fluid chamber via separate outlet channels.

### BACKGROUND OF THE INVENTION

Microfluidics deals with the handling of liquids in the femtolitre to millilitre range. In centrifugal microfluidics, microfluidic systems are operated in rotating systems in order to automate laboratory processes. All standard laboratory processes can be implemented in the system, which is provided with a fluidic module, usually in the form of a disposable polymer cartridge. This means that standard laboratory processes such as pipetting, centrifuging, mixing or aliquoting can be implemented in a microfluidic cartridge so that complete laboratory processes can be automated. For this purpose, the fluidic modules or cartridges contain channels for fluid guidance and chambers for collecting liquids. A predefined sequence of rotational frequencies allows the liquids to be moved through the cartridge in a targeted manner using centrifugal force. Microfluidics is used in laboratory analysis and mobile diagnostics, among other things.

Many possible applications, such as the extraction and purification of DNA (deoxyribonucleic acid), require a variety of liquid reagents such as lysis buffers, binding buffers, wash buffers and elution buffers. Such reagents are usually pre-stored in tubular bags, so-called stick packs, on the microfluidic cartridge. The stick packs can be opened during processing by a combination of centrifugal force and temperature. One disadvantage of this approach is the relatively large amount of space required, as each stick pack is usually pre-stored in a separate chamber if the liquid is to be pumped radially inwards after the stick pack is opened.

### RELATED ART

Methods for transporting liquids in centrifugal microfluidic systems and cartridges are known. For example, Zehnle, S., et al. “Pneumatic Siphon Valving and Switching in Centrifugal Mircofluidics Controlled by Rotational Frequency or Rotational Acceleration”, Microfluidics and Nanofluidics, 19.6 (2015), pages 1259-1269, reveal that a liquid can be distributed to two chambers via two different siphons. Liquid is driven centrifugally from an inlet chamber into a compression chamber. The compression chamber is connected to a first collection chamber via a first fluid channel with a first inverse siphon and to a second collection chamber via a second fluid channel with a second inverse siphon. The apex of the first inverse siphon is disposed radially further out than the apex of the second inverse siphon, and the flow resistance of the first fluid channel is much greater than the flow resistance of the second fluid channel. Initially, rotation takes place at a rotational speed at which air is compressed in the compression chamber. If slow deceleration takes place from this state, the first siphon is filled and liquid is forced out of the compression chamber through the first fluid channel into the first collection chamber. If rapid deceleration takes place from this state, the largest part is driven through the second siphon into the second collection chamber. Here, the liquid is transported into the subsequent chambers exclusively by centrifugal forces, wherein pneumatic pressure is generated in the compression chamber, which is used for switching. DE 10 2013 203 293 A1 describes a corresponding procedure.

### SUMMARY

The object of the present invention is to provide a fluidic module, a fluid handling device and a method which enable two fluid volumes to be transferred from a fluid chamber through different outlet channels.

This object is solved by a fluidic module according to claim 1, a fluid handling device according to claim 8 and the method according to claim 15.

An embodiment may have a fluidic module for use in a centrifugal microfluidic system, comprising: a fluid chamber with a first chamber region and a second chamber region which are separated from one another by a partition wall which extends radially inwards with respect to a centre of rotation, wherein a first liquid volume in the first chamber region can be pre-stored separately from a second liquid volume in the second chamber region, while a common air volume is arranged radially inside the first and second liquid volumes; a first outlet structure comprising at least one first outlet channel which opens into the first chamber region and comprises an outflow barrier for a liquid flow from the first chamber region in the form of a radially inwardly rising channel portion which extends to a first radial position; and a second outlet structure which comprises at least one second outlet channel which opens into the second chamber region and comprises an outflow barrier for a liquid flow from the second chamber region in the form of a radially inwardly rising channel portion which extends to a second radial position, wherein the first radial position is radially further inwards than the second radial position, wherein the fluidic module is configured such that, based on a rotation in which a hydrostatic pressure acting on the first and second liquid volumes prevents the liquid volumes from flowing out of the fluid chamber through the first and second outlet structures, a positive pressure in the common air volume required to transfer the first liquid volume out of the fluid chamber through the first outlet structure against the hydrostatic pressure acting on the first liquid volume is greater than a positive pressure in the common air volume required to transfer the second liquid volume out of the fluid chamber through the second outlet structure against the hydrostatic pressure acting on the second liquid volume.

Another embodiment may have a fluid handling device, comprising: a fluidic module according to the invention; a drive device which is configured to impart rotation to the fluidic module; a pressurising device for generating a positive pressure in the common air volume of the fluidic module; and a control device which is configured to control the drive device to impart the rotation to the fluidic module, at which the first and second liquid volumes are held in the fluid chamber by the acting hydrostatic pressure, to control the pressurising device to generate, from said rotation, a positive pressure in the common air volume sufficient to transfer the second liquid volume out of the fluid chamber against the hydrostatic pressure through the second outlet structure.

Another embodiment may have a method for transferring a first liquid volume from a first chamber region of a fluid chamber through a first outlet structure comprising a first outlet channel, and a second liquid volume from a second chamber region of the fluid chamber through a second outlet structure comprising a second outlet channel, wherein the first chamber region and the second chamber region are separated by a partition wall extending radially inwardly with respect to a centre of rotation, wherein a common air volume is arranged radially within the first and second liquid volumes, wherein the first outlet channel opens into the first chamber region and an outflow barrier in the form of a radially inwardly rising channel portion is provided for a liquid flow from the first chamber region, which extends to a first radial position, wherein the second outlet channel opens into the second chamber region and comprises an outflow barrier in the form of a radially inwardly rising channel portion for a flow of liquid from the second chamber region, which extends to a second radial position, wherein the first radial position is located radially further inwards than the second radial position, such that, starting from a rotation in which a hydrostatic pressure acting on the first and second liquid volumes prevents the liquid volumes from flowing out of the fluid chamber through the first and second outlet structures, respectively, a positive pressure in the common air volume required to transfer the first liquid volume out of the fluid chamber through the first outlet structure against the hydrostatic pressure acting on the first liquid volume is greater than a positive pressure in the common air volume required to transfer the second liquid volume out of the fluid chamber through the second outlet structure against the hydrostatic pressure acting on the second liquid volume, with the following features: imparting a rotation to the fluidic module, at which the first and second liquid volumes are held in the fluid chamber by the acting hydrostatic pressure, based on said rotation, creating a positive pressure in the common air volume sufficient to transfer the second liquid volume out of the fluid chamber against the hydrostatic pressure through the second outlet structure, and transferring the first liquid volume through the first outlet structure out of the fluid chamber by generating a ratio of the hydrostatic pressure acting on the first liquid volume and the positive pressure in the fluid chamber, at which the first liquid volume is transferred through the first outlet structure out of the fluid chamber.

Examples of the present disclosure provide a fluidic module for use in a centrifugal microfluidic system with the following features:

a fluid chamber with a first chamber region and a second chamber region which are separated from one another by a partition wall which extends radially inwards with respect to a centre of rotation, wherein a first liquid volume in the first chamber region can be pre-stored separately from a second liquid volume in the second chamber region, while a common air volume is arranged radially inside the first and second liquid volumes;
a first outlet structure having at least one first outlet channel which opens into the first chamber region and comprises an outflow barrier for a liquid flow from the first chamber region in the form of a radially inwardly rising channel portion which extends to a first radial position; and
a second outlet structure which comprises at least one second outlet channel which opens into the second chamber region and comprises an outflow barrier for a liquid flow from the second chamber region in the form of a radially inwardly rising channel portion which extends to a second radial position,
wherein the first radial position is located radially further inwards than the second radial position, such that, based on a rotation in which a hydrostatic pressure acting on the first and second liquid volumes prevents the liquid volumes from flowing out of the fluid chamber through the first and second outlet structures, a positive pressure in the common air volume required to transfer the first liquid volume out of the fluid chamber through the first outlet structure against the hydrostatic pressure acting on the first liquid volume is greater than a positive pressure in the common air volume required to transfer the second liquid volume out of the fluid chamber through the second outlet structure against the hydrostatic pressure acting on the second liquid volume.

Thus, examples of the present disclosure relate to a fluidic module having fluidic structures for transporting fluids from a chamber to different areas of the fluidic module, such as a centrifugal microfluidic cartridge. The common chamber is configured as a compression chamber to make it possible to generate a positive pressure in the chamber, for example by heating the common air volume in the chamber. The common chamber contains two liquid volumes that are spatially separated from each other, wherein the chamber also serves to generate pressure and thus enables the two liquids to be transported independently of each other. To make this possible, a positive pressure required to transfer the first liquid volume against the hydrostatic pressure acting onto the first liquid volume through the first outlet structure out of the fluid chamber is greater that a positive pressure in the common air volume required to transfer the second liquid volume against the hydrostatic pressure acting onto the second liquid volume through the second outlet structure out of the fluid chamber.

By creating a positive pressure sufficient to transfer the second liquid volume out of the fluid chamber through the second outlet structure, but insufficient to transfer the first liquid volume out of the fluid chamber through the first outlet structure, it is thus possible to transfer the second liquid volume out of the fluid chamber independently of the first liquid volume. Subsequently a first liquid volume can be transferred out of the fluid chamber by creating a ratio of the hydrostatic pressure acting onto the first liquid volume and positive pressure in the fluid chamber, at which the first liquid volume is transferred through the first outlet structure out of the fluid chamber.

In examples, the fluidic resistance of the second outlet structure for a fluid flow out of the fluid chamber is greater than the fluidic resistance of the first outlet structure for a fluid flow out of the fluid chamber. In examples, the fluidic resistance of the second outlet structure for venting out of the fluid chamber is greater than the fluidic resistance of the first outlet structure for a fluid flow of the first liquid volume out of the fluid chamber. This makes it possible to generate sufficient positive pressure in the fluid chamber for the duration of the transport of the first liquid volume via the first outlet structure, wherein the fluid chamber is not vented prematurely via the second outlet structure as soon as the transport via the second outlet structure is complete. To achieve this, the first outlet channel and the second outlet channel may be configured in such a way that the fluidic resistance of the second channel is greater than that of the first channel.

In examples, the second outlet structure includes several second outlet channels opening into the second chamber region, wherein the total fluidic resistance of the several second outlet channels for a fluid flow out of the fluid chamber is greater than the fluidic resistance of the first outlet channel for a fluid flow out of the fluid chamber. Such examples make it possible to transfer parts of the second liquid volume via different outlet channels into different downstream fluidic structures. In examples, the second chamber region is separated into several chamber region portions by at least one radially inwardly extending region partition wall, wherein one of the several second outlet channels opens into each of the chamber region portions. This makes it possible to transfer separated parts of the second liquid volume into different downstream fluidic structures.

The term “outlet structure” as used herein refers to one or more outlet channels. The term “fluidic resistance of an outlet structure” thus refers to the fluidic resistance of the outlet channel if the outlet structure comprises one outlet channel, or to the total fluidic resistance of several outlet channels if the outlet structure comprises several outlet channels.

In examples, a ratio of the fluidic resistance of the second outlet structure to the fluidic resistance of the first outlet structure when filled with the same fluid is at least a factor of 30, preferably a factor of at least 50. Thus, in examples, the second outlet structure may have a fluidic resistance for venting the fluid chamber such that the positive pressure in the air volume in the fluid chamber required to transfer the first liquid volume out of the fluid chamber through the first outlet structure against the hydrostatic pressure acting on the first liquid volume at a given rotational frequency and at a given hydrostatic height of the apex of the first outlet channel is producible in the fluid chamber. It has been shown that a factor of 30 can be sufficient here, wherein a factor of at least 50 is preferred in order to enable reliable transfer of the first liquid volume out of the first outlet structure.

In embodiments, fluidic structures of the fluidic module are configured to allow the second outlet structure to remain at least partially filled with liquid or to be refilled with liquid following the transfer of the second liquid volume through the second outlet structure. As a result, the fluidic resistance of the second outlet structure can be determined by the viscosity of the liquid in the second outlet structure during a liquid transfer through the first outlet structure and thus a pressure build-up in the fluid chamber can be better supported than if the second outlet structure would be filled with gas.

In examples, the fluidic structures have a radially inwardly extending projection in an outer chamber wall of the second chamber region configured to retain a part of the liquid of the second liquid volume in the second chamber region upon transfer of the liquid of the second liquid volume through the second outlet structure and to subsequently be swept by changing the rotational frequency so that liquid enters the second outlet structure.

In examples, the fluidic structures include an intermediate chamber disposed in or fluidly coupled to the second outlet structure and configured to be filled with liquid of the second liquid volume upon transfer of liquid of the second liquid volume through the second outlet structure, and to at least partially fill the one or several second outlet channels with the liquid after the transfer. The intermediate chamber may be configured not to empty completely when the liquid of the second liquid volume is transferred through the second outlet structure, so that liquid may be caused to remain in the one or several second outlet channels after the transfer and thus the fluidic resistance of the outlet structure depends on the viscosity of the liquid, which is many times higher than that of gas, such as air.

In examples, the fluidic structures include an orifice of the of the one or more second outlet channels into a downstream fluid chamber configured to retain or return a part of the fluid of the second liquid volume into the second outlet channel or the second outlet channels after transfer through the second outlet structure.

In examples, the fluidic structures include chamber walls of the fluid chamber which are configured in such a way that liquid of the first liquid volume which evaporates by heating and condenses on the chamber walls is at least partially guided into the second chamber region by centrifugation and at least partially fills the one or several second outlet channels there.

Corresponding fluidic structures can thus be used to ensure that the second outlet structure, i.e. the one or several outlet channels thereof, can be at least partially filled with liquid of the second or first liquid volume after the transfer of the second liquid volume or at least a large part thereof. Thus, during liquid transfer through the first outlet structure, the fluidic resistance of the second outlet structure can be determined by the viscosity of the liquid and not by the gas, such as air. This favours a pressure build-up to generate the positive pressure required for fluid transfer through the first outlet structure.

In examples, the first outlet channel comprises a first inverse siphon channel, wherein the apex of the first inverse siphon channel extends to the first radial position. In examples, the second outlet channel comprises a second inverse siphon channel, wherein the apex of the second inverse siphon channel extends to the second radial position. In such examples, the hydrostatic pressure acting on the respective liquid volume, in particular the respective liquid volume in the radially inwardly extending portion of the outlet channel, is easily adjustable by the radial position of the apex of the respective siphon channel.

The fluid chamber is a compression chamber configured to enable the generation of positive pressure in it. In examples, the fluid chamber is not vented when the first and second liquid volumes are pre-stored in the first and second chamber regions. In examples, there may further be provided a vent channel connecting the fluid chamber to further fluidic structures of the fluidic module or the outside, the vent channel having a vent resistance enabling it to create a positive pressure in the fluid chamber sufficient to transfer the second liquid volume out of the fluid chamber through the second outlet structure. In other words, in examples, the fluid chamber may be vented, wherein the venting provides however sufficient vent resistance to allow sufficient positive pressure to be generated in the fluid chamber despite the venting to allow transfer of the first and second liquid volumes from the fluid chamber as described herein.

Examples of the present disclosure provide a fluid handling device with such a fluidic module, a drive device configured to impart rotation to the fluidic module, a pressurising device for generating a positive pressure in the common air volume and a control device. The control device is configured to control the drive device to impart rotation to the fluidic module, at which the first and second liquid volumes are maintained in the fluid chamber by the acting hydrostatic pressure, and to control the pressurising device to generate, based on the said rotation, a positive pressure in the common air volume sufficient to transfer the second liquid volume out of the fluid chamber against the hydrostatic pressure through the second outlet structure.

Examples thus provide a fluid handling device with a fluidic module as disclosed herein, wherein the pressurising device is configured to generate a positive pressure in the common air volume sufficient to transfer the second liquid volume out of the fluid chamber through the second outlet structure. The pressurising device may be configured to generate the positive pressure such that it is sufficient to transfer the second liquid volume out of the fluid chamber through the second outlet structure, but not to transfer the first liquid volume out of the fluid chamber through the first outlet structure. This makes it possible to transfer the liquid volumes independently of each other through the respective outlet structure. For this purpose, the pressurising device may be configured to transfer such a positive pressure in the fluid chamber after transferring the second liquid volume that the first liquid volume is transferred out of the fluid chamber through the first outlet structure.

In examples, the pressurising device may be provided with a heating device configured to heat the common air volume in the fluid chamber to generate the positive pressure. This makes it easy to generate the required positive pressure in the fluid chamber. In other examples, the pressurising device may comprise substances in the fluid chamber that are configured to generate the positive pressure by a chemical reaction.

In examples, the control device may be configured to reduce a rotational speed of the rotation of the fluidic module to at least assist a transfer of the first liquid volume through the first outlet structure out of the fluid chamber. In such examples, by reducing the rotational speed, the hydrostatic pressure opposing a transfer of the first liquid volume through the first outlet structure can be reduced such that the positive pressure generated and/or remaining in the fluid chamber outweighs the hydrostatic pressure opposing the flow of the first liquid volume through the first outlet structure.

In embodiments, after transferring the second liquid volume through the second outlet structure and after reducing the positive pressure in the air volume in the fluid chamber, the control device may be configured to control the pressurising device to generate a positive pressure in the air volume in the fluid chamber sufficient to transfer the first liquid volume out of the fluid chamber against the hydrostatic pressure through the first outlet structure.

The fluid handling device may thus be configured to create a transfer of the first liquid volume through the first outlet structure by either increasing the positive pressure in the pressure chamber to outweigh the opposing hydrostatic pressure, or by reducing the hydrostatic pressure by reducing the rotational speed so that the positive pressure in the fluid chamber predominates.

In examples, the pressurising device comprises a heating device, wherein the control device is configured to switch off the heating device after transferring the second liquid volume through the second outlet structure, thereby cooling the air volume in the fluid chamber, and to control the heating device, after cooling the air volume in the fluid chamber and reducing a resulting negative pressure in the air volume in the fluid chamber, to heat the air volume in the fluid chamber to create a positive pressure in the air volume in the fluid chamber sufficient to transfer the first liquid volume out of the fluid chamber against the hydrostatic pressure through the first outlet structure. Examples thus allow the first and second liquid volumes to be transferred independently of each other in a flexible manner.

Examples of the present disclosure provide methods for transferring a first liquid volume from a first chamber region of a fluid chamber through a first outlet structure having a first outlet channel, and a second liquid volume from a second chamber region of the fluid chamber through a second outlet structure having a second outlet channel, wherein the first chamber region and the second chamber region are separated from each other by a partition wall extending radially inwardly with respect to a centre of rotation, wherein a common air volume is disposed radially within the first and second liquid volume, wherein the first outlet channel opens into the first chamber region and includes an outflow barrier for a liquid flow from the first chamber region in the form of a radially inwardly rising channel portion which extends to a first radial position, wherein the second outlet channel opens into the second chamber region and includes an outflow barrier for a liquid flow from the second chamber region in the form of a radially inwardly rising channel portion which extends to a second radial position, wherein the first radial position is located radially further inwards than the second radial position, such that, based on a rotation in which a hydrostatic pressure acting on the first and second liquid volumes prevents the liquid volumes from flowing out of the fluid chamber through the first and second outlet structures, a positive pressure in the common air volume required to transfer the first liquid volume out of the fluid chamber through the first outlet structure against the hydrostatic pressure acting on the first liquid volume is greater than a positive pressure required to transfer the second liquid volume out of the fluid chamber through the second outlet structure against the hydrostatic pressure acting on the second liquid volume. The method comprises imparting a rotation to the fluidic module, at which the first and second volumes of fluid are held in the fluid chamber by the acting hydrostatic pressure, and based on this rotation, generating a positive pressure in the common air volume sufficient to transfer the second liquid volume out of the fluid chamber against the hydrostatic pressure and subsequently transferring the first liquid volume out of the fluid chamber through the first outlet structure.

In examples, two stick packs are pre-stored in the fluid chamber, the radially outer end of one stick pack being located in the first chamber region and the radially outer end of the other stick pack being located in the second chamber region. In examples, the method involves opening the stick packs to allow the liquids to leave the stick packs. In examples, the stick packs may be opened during processing by a combination of centrifugal force and temperature.

In examples, the method for transferring the first liquid volume out of the fluid chamber includes increasing the positive pressure, for example by heating the common air volume, and/or reducing the hydrostatic pressure, for example by reducing the rotational speed.

In examples of the method, positive pressure generated to transfer the second liquid volume from the fluid chamber is not sufficient to transfer the first liquid volume out of the fluid chamber against the hydrostatic pressure. In examples of the method, generating the positive pressure involves heating the common air volume or causing a chemical reaction in the fluid chamber. Examples of the method include reducing a rotational speed of the rotation of the fluidic module to assist and/or cause a transfer of the first liquid volume through the first outlet structure out of the fluid chamber. In such examples, after transferring the second liquid volume through the second outlet structure, the method may include reducing the rotational speed of rotation of the fluidic module to reduce the hydrostatic pressure acting on the first liquid volume such that the positive pressure in the air volume in the fluid chamber is sufficient to transfer the first liquid volume out of the fluid chamber against the hydrostatic pressure through the first outlet structure.

In examples of the method, after the second liquid volume has been transferred through the second outlet structure, the positive pressure in the air volume in the fluid chamber is reduced. The positive pressure may be reduced, for example, by the second outlet structure and/or an additional vent channel. In examples, after the positive pressure has been reduced, a positive pressure is generated in the air volume in the fluid chamber, which is sufficient to transfer the first liquid volume out of the fluid chamber against the hydrostatic pressure through the first outlet structure. In such examples, after transferring the second liquid volume through the second outlet structure, a heating device used to generate the positive pressure may be switched off to cool the air volume in the second fluid chamber. After a reduction of a negative pressure in the air volume caused by cooling, the air volume in the fluid chamber may then be heated to generate a positive pressure in the air volume sufficient to transfer the first liquid volume out of the fluid chamber against the hydrostatic pressure through the first outlet structure.

In examples of the method, subsequent to transferring the second liquid volume through the second outlet structure, the second outlet structure becomes at least partially filled with liquid such that the fluidic resistance of the second outlet structure during transfer of the first liquid volume through the first outlet structure is determined by the viscosity of the liquid in the second outlet structure.

If this refers to a liquid volume being transferred, this may mean that the entire liquid of the liquid volume is transferred or at least a large part of the liquid volume is transferred. In examples, a part of the liquid of the transferred liquid volume may thus remain in the initial structure or the transfer structure.

Examples of the present invention thus enable a space-saving concept by utilising a fluid chamber several times as a pump structure. In examples, the fluid chamber may be used to pump several liquids or liquid volumes through different outlet channels. Thus, examples of the present invention create a microfluidic structure with which two spatially separated fluids present within a single chamber can be pumped selectively into areas of a microfluidic cartridge. The liquid can only be transported by generating positive pressure, for example by increasing the temperature. No additional pneumatic chambers are required, which enables a compact structure.

### BRIEF DESCRIPTION OF THE DRAWINGS

Embodiments of the present invention will be detailed subsequently referring to the appended drawings. They show:

FIG. 1 schematically a fluidic module according to an example;

FIGS. 2A to 2D schematic representations of an example of a fluidic module during different operating phases;

FIGS. 3A to 3D schematic views of an example of a fluidic module during different operating phases;

FIG. 4 schematically another example of a fluidic module;

FIGS. 5 to 7 schematic examples of fluidic modules in which fluidic structures are configured to support pressurising the fluid chamber to transfer the first liquid;

FIG. 8 schematically another example of a fluidic module in which the connection between the outlet channel and a subsequent chamber is configured such that a part of the transferred liquid volume does not enter the subsequent chamber; and

FIGS. 9A and 9B schematic representations of examples of fluid handling devices.

### DETAILED DESCRIPTION OF THE INVENTION

In the following, examples of the present disclosure are described in detail using the accompanying drawings. It should be noted that identical elements or elements having the same functionality are provided with identical or similar reference signs, wherein a repeated description of elements provided with the same or similar reference sign may typically be omitted. In particular, identical or similar elements may each be provided with reference signs that have the same number with a different or no lower case letter. Descriptions of elements that have the same or similar reference signs may be interchangeable. In the following description, many details are described to provide a more thorough explanation of examples of the disclosure. However, it is obvious to experts that other examples may be implemented without these specific details. Features of the different examples described can be combined with each other, unless features of a corresponding combination are mutually exclusive or such a combination is expressly excluded.

Before explaining examples of the present disclosure in more detail, definitions of some terms used herein are provided.

The fluidic resistance of a channel can be defined as a quotient of the pressure drop Δp in a channel and the flow rate q: R=Δp/q. Depending on the channel cross-section geometry, the pressure drop can be analytically derived or approximated. The fluidic resistance of a channel can be determined, for example, by measuring the pressure drop and the flow rate. If nothing else is specified here, it can be assumed that fluid resistances for the same fluids at the same temperatures are being compared.

The rotation caused by centrifugation results in hydrostatic pressure. The hydrostatic pressure p_{Hydrostatisch} on a liquid column in a channel in a centrifugal gravity field can be calculated using the following formula:

$$Δ {p}_{h y d r o s t a t c} = \frac{ρ}{2} * {ω}^{2} * ( {r}_{a}^{2} - {r}_{i}^{2} )$$

Here, ρ stands for the density of the liquid, ω for the angular velocity at which the channel rotates around the centre of rotation, rₐ for the outer radius of the liquid column and rᵢ for the inner radius of the liquid column.

The total pressure generated in a fluid chamber, which is partly filled with a liquid and partly with a gas, such as air, is made up of two components, a pressure generated by the ideal gas law and a vapour pressure generated by the evaporation of the liquids. The total pressure of the system pₜₒₜₐₗ may be described by the following formula:

$${p}_{total} = {p}_{g a s} + Φ {p}_{v a p o r} ( T ) = \frac{n R T}{V} + Φ {p}_{v a p o r} ( T )$$

Here, p_{gas} describes the pressure generated by the ideal gas law, and pᵥₐₚₒᵣ describes the pressure generated by the evaporated liquid. The formula for the proportion of vapour pressure consists usually in empirically determined correlations, which are determined individually for each liquid and depend on the temperature. ϕ describes the relative humidity of the air. At 100%, the air is completely saturated with a liquid. In microfluidic structures, the air is usually completely saturated.

Examples of fluidic structures, e.g. microfluidic structures, are fluid channels and fluid chambers. Fluidic structures can define an overflow structure that can be used to measure liquid volumes. The basic principle here is that the liquid first fills a chamber with a defined volume and the remaining liquid is then transported to another chamber. Compression chambers are chambers that either have no venting or only venting with high fluidic resistance. This allows a pressure pₜₒₜₐₗ to build up in these chambers, which is described in the formula defined above.

Unless otherwise specified, positive pressure herein can be understood as the pressure difference between the ambient pressure (usually atmospheric pressure: patm ˜1013 hPa) and a generated higher pressure (>patm), while negative pressure herein can be understood as the pressure difference between the ambient pressure and a generated lower pressure (<patm).

The term “liquid” as used herein includes, as is obvious to those skilled in the art, in particular liquids containing solid components, such as suspensions, biological samples and reagents. In particular, this includes buffer solutions, such as lysis buffers, binding buffers, wash buffers and elution buffers, as used in laboratory analysis and mobile diagnostics.

An inverse siphon channel is understood herein to be a microfluidic channel or portion of a microfluidic channel in a fluidic module (a centrifugal microfluidic cartridge) in which the inlet and outlet of the channel have a greater distance from the centre of rotation than an intermediate area of the channel. A siphon apex is the area of an inverse siphon channel in a fluidic module at a minimum distance from the centre of rotation.

A fluidic module herein means a module, such as a cartridge, having microfluidic structures configured to enable fluid handling as described herein. A centrifugal microfluidic fluidic module (cartridge) is a corresponding module that can be subjected to rotation, for example in the form of a fluidic module that can be inserted into a rotational body or a rotational body.

Where reference is made herein to a fluid channel, this refers to a structure whose length dimension from a fluid inlet to a fluid outlet is greater, for example more than 5 times or more than 10 times greater, than the dimension or dimensions that define the flow cross section. Thus, a fluid channel has a flow resistance or fluidic resistance for flow through it from the fluid inlet to the fluid outlet. In contrast, a fluid chamber herein is a chamber having such dimensions that when flowing through the chamber, a negligible flow resistance occurs compared to connected channels, which can be, for example, 1/100 or 1/1000 of the flow resistance of the channel structure connected to the chamber with the smallest flow resistance.

Examples of the invention nay be used in particular in the field of centrifugal microfluidics, which involves the processing of liquids in the picolitre to millilitre range. Accordingly, the fluidic structures may have suitable dimensions in the micrometre range for handling corresponding liquid volumes.

If the term “radial” is used here, this means radial with respect to the centre of rotation around which the fluidic module or the rotational body can rotate. In the centrifugal field, a radial direction away from the centre of rotation is therefore radially descending and a radial direction towards the centre of rotation is radially ascending. A fluid channel whose beginning is closer to the centre of rotation than its end is therefore radially descending, while a fluid channel whose beginning is further away from the centre of rotation than its end is radially ascending. A channel that has a radially ascending portion therefore has directional components that ascend radially or run radially inwards. It is clear that such a channel does not have to run exactly along a radial line, but may run at an angle to the radial line or be curved.

Unless otherwise specified herein, room temperature (20° C.) shall be assumed for temperature-dependent variables.

Examples of the present disclosure relate to microfluidic structures on a centrifugal microfluidic cartridge, by means of which fluids can be transported via channels out of a chamber to different areas on the cartridge. At least two liquid volumes are located in spatially separated chamber regions, which can be described as compartments, in one chamber. The air volume in the chamber makes it possible to exert pressure, for example pneumatically and thermally induced, on various liquids. The liquids can be pumped out of this chamber through channels that open into the respective chamber regions. At least one of these channels may have such a high fluidic resistance that in the event of a complete liquid transfer through this channel, a sudden drop in pressure in the common chamber is not possible. In other words, the fluidic resistance of this channel may be so high that even if this channel acts as a vent channel, a positive pressure can be generated in the common chamber that is sufficient to transfer the fluid from the other chamber region through the other channel. The structures described therefore allow different liquids to be pumped from a single chamber into different areas of a microfluidic cartridge at different times or simultaneously, thus increasing the integration density of the microfluidics.

Examples of the present disclosure provide for a fluidic module with microfluidic structures that allow different fluids to be transferred from the same fluid chamber.

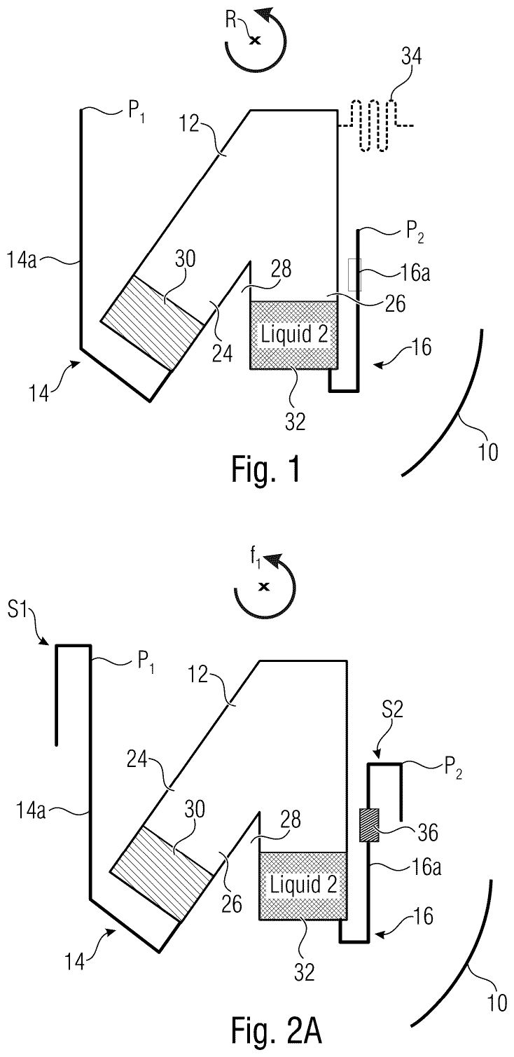

FIG. 1 shows an example of a fluidic module 10 having fluidic structures that include a fluid chamber 12, a first outlet channel 14 and a second outlet channel 16. The fluid chamber 12 is provided with a first chamber region 24 and a second chamber region 26. The fluidic module 10 is rotatable about a centre of rotation R and may be configured as a rotational body or as a module that can be inserted into a rotational body. The first chamber region 24 and the second chamber region 26 are separated from one another by a partition wall 28, which extends radially inwards with respect to the centre of rotation R. The partition wall 28 has such a radial height that the two liquid volumes are separated from one other when they are driven centrifugally into radially outer portions of the chamber regions 24, 26. Thus, a first liquid volume 30 in the first chamber region 24 can be pre-stored separately from a second liquid volume 32 in the second chamber region 26. Corresponding liquid volumes 30 and 32 are shown in FIG. 1. The liquid volumes can be pre-stored in the respective chamber regions, for example, by inserting two stick packs into the chamber 12, which overlap in the radially inward part and whose ends are each located in one of the two chamber regions 24, 26. When the stick packs are opened and ejected, the two liquid volumes they contain are located in the first chamber region 24 and the second chamber region 26 respectively. These two liquid volumes may be the same liquid or different liquids. The rotation of the fluidic module 10 around the centre of rotation R creates a centrifugal gravitational field that prevents the two liquids from mixing due to the geometric configuration of the chamber with the partition wall 28 projecting radially inwards.

In examples, the chamber regions 24 and 26 may each have an elongate shape when viewed from above the fluidic module, extending in different radial directions, with inner ends of the chamber regions overlapping to define a common fluid chamber region. This makes it possible to place two stick packs in a common chamber in a space-saving manner, wherein the liquids contained therein can be pre-stored in spatially separated chamber regions.

A microfluidic channel is connected to each of the two chamber regions, usually but not necessarily at the radially outermost point of the chamber region. Thus, the first outlet channel 14 is fluidically coupled to a radially outer portion of the first chamber region 24 and the second outlet channel 16 is fluidically coupled to a radially outer portion of the second chamber region 26. The first outlet channel thus opens into the first chamber region 24 and has an outflow barrier for a liquid flow out of the first chamber region 24 in the form of a radially rising channel portion 14a, which extends to a first radial position P₁. The second outlet channel 16 opens into the second chamber region 26 and has an outflow barrier for a fluid flow out of the second chamber region 26 in the form of a radially inwardly rising channel portion 16a, which extends to a second radial position P₂. The first radial position P₁ is radially further inwards than the second radial position P₂. In examples, one or both of the outlet channels 14 and 16 may open into a fluid chamber at the radial position P₁, P₂. In examples, the first outlet channel 14 and/or the second outlet channel 16 may have an inverse siphon channel, the apex of which is located at the first radial position P₁ or second radial position P₂.

The fluidic module 10 may be subjected to a rotation in which a hydrostatic pressure acting on the first and second liquid volumes prevents the liquid volumes from flowing out of the fluid chamber 12 through the first and second outlet channels 14, 16. A common air volume is arranged above the liquid volumes 30 and 32 in the fluid chamber 12. Based on such rotation, a positive pressure in the common air volume required to transfer the first liquid volume 30 out of the fluid chamber 12 through the first outlet channel 14 against the hydrostatic pressure acting on the first liquid volume 30 is greater than a positive pressure in the common air volume required to transfer the second liquid volume 32 out of the fluid chamber 12 through the second outlet channel 16 against the hydrostatic pressure acting on the second liquid volume 32. To achieve this, both channels may have different radial siphon heights and/or different fluidic resistances.

The fluid chamber 12 may be configured as a compression chamber which, apart from the first and second outlet channels, is fluid-tight, i.e. has no vent openings. As shown in FIG. 1, a vent channel 34 may optionally be provided, which fluidically connects the fluid chamber 12 with further fluidic structures of the fluidic module 10 or the outside.

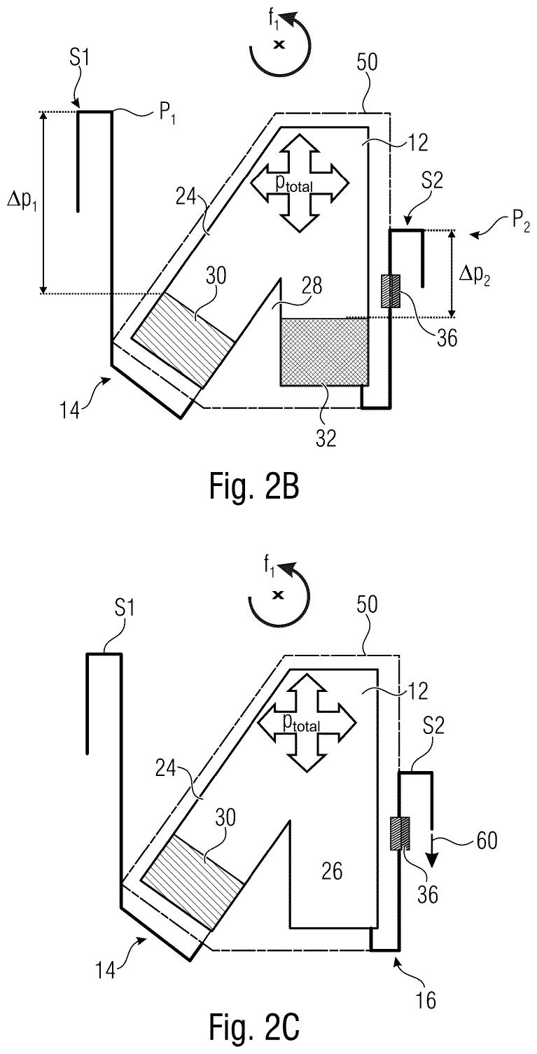

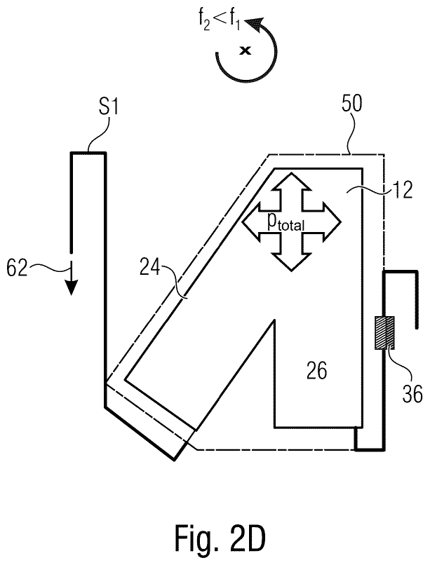

FIG. 2A schematically shows fluidic structures of the fluidic module 10, wherein the first outlet channel 14 has a first inverse siphon S1 and the second outlet channel 16 has a second inverse siphon S2. An apex of the first inverse siphon S1 is located at the radial position P₁ and an apex of the second inverse siphon S2 is located at the radial position P₂. As shown schematically in FIG. 2A, the second outlet channel 16 has a fluidic resistance 36. The fluidic resistance 36 is sufficiently large to allow, after a complete transfer of the second liquid volume 32 through the second outlet channel 16, to build up such a positive pressure in the common air volume 12 that the first liquid volume 30 can be transferred through the first outlet channel 14.

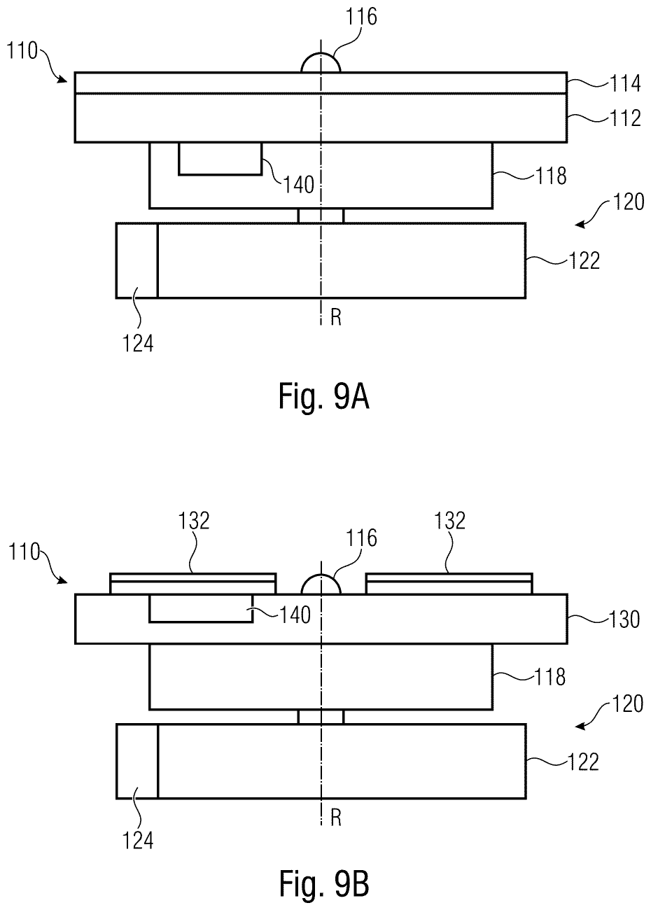

Before examples of fluid handling devices according to the invention and examples of methods according to the invention are described with reference to FIGS. 2A to 2D and 3A to 3D and 4 to 8, general features of examples of fluid handling devices according to the invention are first described with reference to FIGS. 9A and 9B.

FIGS. 9A and 9B show examples of centrifugal microfluidic systems or fluid handling devices utilising or including a fluidic module as described herein. In other words, the fluidic module in the systems of FIGS. 9A and 9B may be any of the fluidic modules described herein. The fluid handling devices each have the fluidic module, a drive device, a pressurising device and a control device.

FIG. 9A shows a fluid handling device with a fluidic module 110, a drive device 120, a pressurising device 140 and a control device 124. The fluidic module 110 is a rotational body consisting of a substrate 112 and a cover 114. The substrate 112 and the cover 114 may be circular in plan view, with a central opening through which the rotational body 110 can be attached to a rotating part 118 of the drive device 120 via a conventional attachment device 116. The rotating part 118 is rotatably mounted on a stationary part 122 of the drive device 120. The drive device 120 may be, for example, a conventional centrifuge, which may have an adjustable rotational speed, or a CD or DVD drive. The control device 124 is configured to control the drive device 120 to impart rotation or rotations of different rotational frequencies to the rotational body 110, and to control the pressurising device 140. As is obvious to those skilled in the art, the control device 124 may be implemented, for example, by an appropriately programmed computing device or a user-specific integrated circuit. The control device 124 may further be configured to, in response to manual input from a user, control the drive device 120 to effect the required rotations of the rotational body and/or control the pressurising device 140. In either case, the control device 124 may be configured to control the drive device 120 to impart the required rotation to the rotational body 110 and/or to control the pressurising device 140 to implement embodiments of the invention as described herein. A conventional centrifuge with only one direction of rotation may be used as the drive device 120.

The rotational body 110 is provided with the fluidic structures as described herein. The required fluidic structures may be formed by cavities and channels in the cover 114, the substrate 112 or in the substrate 112 and the cover 114. In embodiments, for example, fluidic structures may be depicted in the substrate 112, while filler openings and vent openings are formed in the cover 114. In embodiments, the structured substrate (including filler openings and vent openings) is arranged at the top and the cover is arranged at the bottom. In examples, the cover may be removable, for example to allow stick packs to be inserted into the fluid chamber. In examples, the stick packs can be inserted before the cover is removably or permanently attached to the substrate.

In an alternative embodiment shown in FIG. 9B, fluidic modules 132 are inserted into a rotor 130 and together with the rotor 130 form the rotational body 110. The fluidic modules 132 may each have a substrate and a cover, in which corresponding fluidic structures may in turn be formed. The rotational body 110 formed by the rotor 130 and the fluidic modules 132 can in turn be rotated by the drive device 120 which is controlled by the control device 124. Furthermore, the pressurising device 140, which may be controlled by the control device 124, is again shown in FIG. 9B.

In FIGS. 9A and 9B, the centre of rotation about which the fluidic module or the rotational body is rotatable is designated with R.

In embodiments of the invention, the fluidic module or the rotational body including the fluidic structures may be formed from any suitable material, for example a plastic such as PMMA (polymethyl methacrylate), PC (polycarbonate), PVC (polyvinyl chloride) or PDMS (polydimethylsiloxane), glass or the like. The rotational body 110 may be regarded as a centrifugal microfluidic platform. In embodiments, the fluidic module or the rotational body may be formed from a thermoplastic, such as PP (polypropylene), PC, COP (cyclic olefin polymer), COC (cyclic olefin copolymer) or PS (polystyrene).

In examples, the pressurising device 140 may be provided with a heating device configured to heat the common air volume in the fluid chamber. The heating device may, for example, be configured as a contact heating to heat the fluidic module locally or globally. The heating device may, for example, be provided in the rotating part 118 of the drive unit 120 or in the rotor 130. Alternatively, the heating device may also be configured as a non-contact heating that heats the fluidic module, for example by means of radiation heat.

Corresponding fluid handling devices may be configured to implement operations and methods as described below.

As shown in FIG. 2A, in the initial state, the control device 124 controls the drive device 120 to rotate the fluidic module 10 at a rotational frequency f₁. During such a rotation, the fluidic module 10 is in the initial state, wherein the first liquid volume 30 is located in the first chamber region 24 and the second liquid volume 32 is located in the second chamber region 26. The liquid volumes are held in position by the rotation with the frequency f₁ by means of the centrifugal force. In the examples described below, it is assumed that the pressurising device is a heating device. In alternative examples, other pressurising devices may be implemented, for example those containing substances in the fluid chamber configured to generate the positive pressure by a chemical reaction, or those generating positive pressure by mechanical movement, for example by means of a pumping diaphragm.

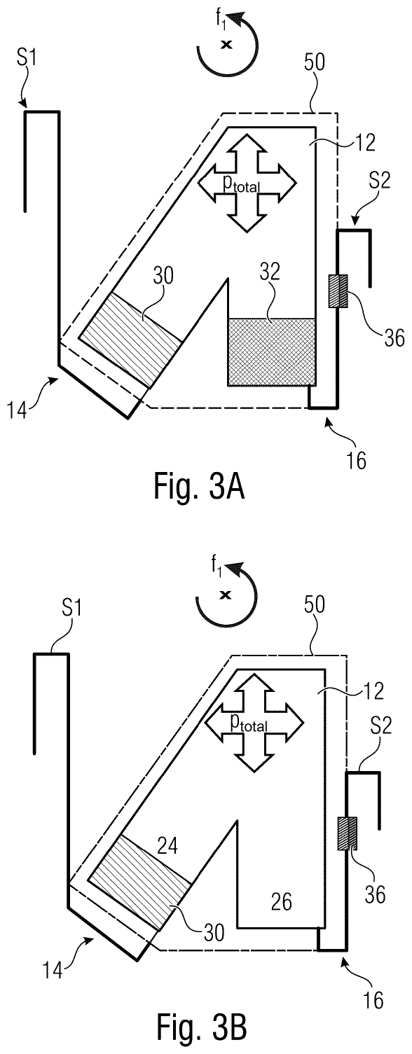

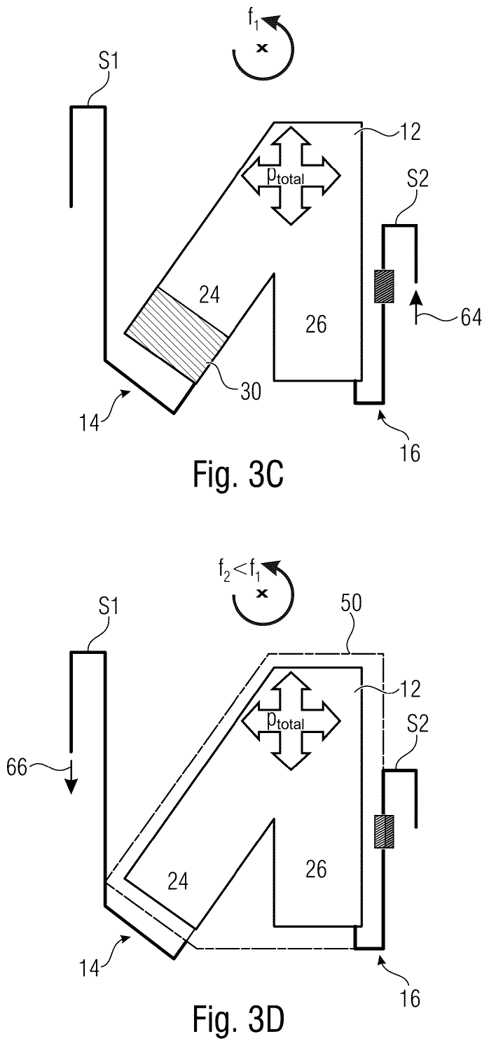

In the following, examples of methods according to the invention are described with reference to the fluidic modules shown in FIGS. 2A to 2D and 3A to 3D. It needs no separate explanation that the control device of the fluid handling device is configured in each case to control the drive device and the pressurising device in order to implement the corresponding functionalities.

Starting from the state shown in FIG. 2A, a positive pressure pₜₒₜₐₗ is generated in the fluid chamber 12 by increasing the temperature, as shown in FIG. 2B. The heating device is configured to heat at least one area 50 of the fluidic module, which comprises at least a part of the fluid chamber 12. The heating causes the common air volume in the fluid chamber 12 to expand, creating a positive pressure. This positive pressure counteracts the centrifugal force acting on the liquid volumes in channels 14 and 16. The hydrostatic pressure acting on the first liquid volume 30 when the first liquid reaches the point P1 is designated with Δp₁ in FIG. 2B and the hydrostatic pressure acting on the second liquid volume 32 when the second liquid reaches the point P2 is designated with Δp₂ in FIG. 2B. As may be seen in FIG. 2B, the hydrostatic pressure acting on the first liquid volume 30 when it reaches the point P1 is greater than the hydrostatic pressure acting on the second liquid volume 32 when it reaches the point P2. The pressurising device is controlled in such a way that the positive pressure pₜₒₜₐₗ is set in such a way that it is lower than the hydrostatic pressure Δp₁ and higher than the hydrostatic pressure Δp₂. As a result, the positive pressure generated is not sufficient to overcome the hydrostatic pressure Δp₁ and the first liquid volume 30 is not transferred through the first outlet channel 14 and remains in the fluid chamber 12. Since the hydrostatic pressure Δp₂ is smaller than the positive pressure pₜₒₜₐₗ, the second liquid volume 32 is transported out of the fluid chamber 12 through the second outlet channel 16, for example into a downstream structure (not shown). This is shown in FIG. 2C by an arrow 60. Due to the high fluidic resistance 36 of the second outlet channel 16, sufficient pressure is maintained in the fluid chamber 12, even if the liquid volume 32 has been completely transferred. By reducing the rotational frequency from the frequency f₁ to a frequency f₂, the centrifugal back pressure Δp₁ can now be reduced so that the remaining positive pressure pₜₒₜₐₗ can be used to transport the liquid volume 30 out of the fluid chamber 12 through the first outlet channel 14, as shown in FIG. 2D by an arrow 62. The reduction in the rotational frequency, as shown in FIG. 2D, takes place at a time when the positive pressure in the fluid chamber 12 has not yet been reduced by the second outlet channel acting as a vent channel.

Thus, examples of the present disclosure enable transfer of the two liquid volumes 30, 32 out of the fluid chamber 12 independently of each other. Examples thus enable sequential transport of two liquid volumes out of the same fluid chamber.

According to examples, the control device is thus configured to control the pressurising device to generate an positive pressure in the fluid chamber such that the second liquid volume, i.e. the second liquid, is transferred out of the fluid chamber, but not the first liquid volume. The first liquid volume, i.e. the first liquid, can then be transferred ouf of the fluid chamber in different ways. As described above with reference to FIGS. 2A to 2D, the rotational frequency may be reduced to transfer the first liquid volume. Alternatively, the control device may be configured to control the pressurising device to generate such a positive pressure in the fluid chamber after the transfer of the second liquid volume that the first liquid volume is transferred out of the fluid chamber.

A further example of how the first liquid volume can be transferred from the fluid chamber is now described with reference to FIGS. 3A to 3D. FIG. 3A again shows the state as shown and described in FIG. 2B. The positive pressure pₜₒₜₐₗ in turn transfers the second liquid volume 32 out of the fluid chamber 12 through the second outlet channel 16. After the transfer of the second liquid volume out of the fluid chamber 12, the second outlet channel 16 serves as a vent channel through which a pressure compensation can be carried out under constant rotation, by means of which the pressure in the fluid chamber 12 is reduced, as shown in FIG. 3B. If the fluid chamber is now cooled back to ambient temperature, a negative pressure is created in the fluid chamber 12, which can now also be reduced through the second outlet channel 16, as shown in FIG. 3C. This rebalances the system and other operations can be carried out simultaneously on the fluidic module, the cartridge, without having to heat continuously. Heating at a simultaneously low rotational frequency may then be used to overcome the relatively low centrifugal back pressure in the first outlet channel 14 by a high pneumatic pressure pₜₒₜₐₗ in the fluid chamber 12 and thus initiate the transport of the first liquid volume 30 out of the fluid chamber 12, as shown in FIG. 3D and indicated by an arrow 66. Again, the frame 50 in FIGS. 3A to 3D marks a possible jointly heated space.

In the example shown with reference to FIGS. 3A to 3D, the rotational frequency was lowered in order to transfer the first liquid volume out of the fluid chamber while heating at the same time. It is not necessary to reduce the rotational frequency to transfer the first liquid volume if the pressure in the fluid chamber 12 is increased so that it is higher than the hydrostatic pressure while the rotational frequency remains the same.

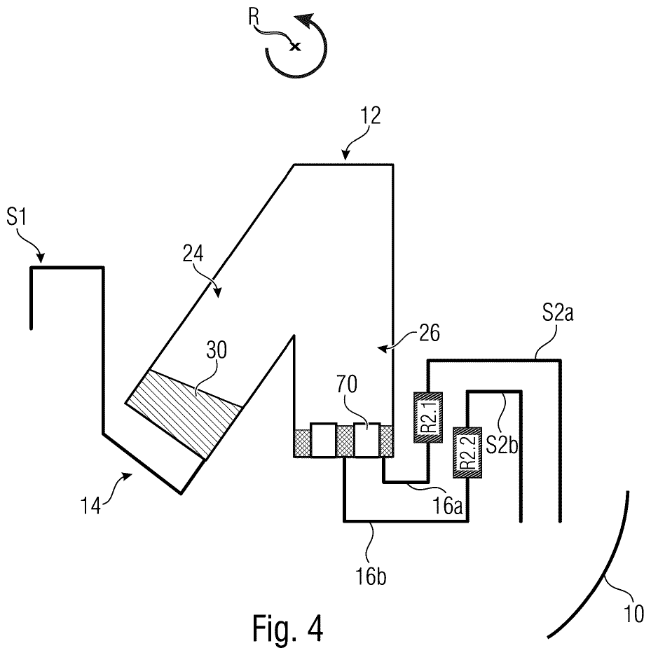

FIG. 4 shows an example of a fluidic module 10 in which several channels with fluidic resistance lead from the second chamber region 26 into downstream structures. As shown in FIG. 4, the fluidic module is provided with two second outlet channels 16a and 16b, each being provided with a second inverse siphon S2a and S2b. The radial position of the apex of the inverse siphon channels S2a and S2b lies radially outside the apex of the siphon channel S1 of the first outlet channel 14. The second outlet channel 16a has a fluidic resistance R2.1 and the second outlet channel 16b has a fluidic resistance R2.2. The total fluidic resistance of the several second outlet channels 16a and 16b, that is R2.1−R2.2/(R2.1+R2.2), is again configured to generate a positive pressure in the fluid chamber 12 that allows the first liquid volume 30 to be transferred through the first outlet channel 14. In examples, the total fluidic resistance of the several second outlet channels 16a, 16b may be greater than the fluidic resistance of the first outlet channel 14.

In examples of the present disclosure, the outlet channels may be configured to have decreasing fluidic resistances as the outflow barrier increases. The further radially inwards the position to which the radially inwardly rising channel portion of an outlet channel extends, the higher the outflow barrier of this outlet channel. In general, it may be said in examples that the channels have decreasing fluidic resistance as the outflow barrier increases.

As shown in FIG. 4, one or more region partition walls 70 extending radially inwardly from a radially outer end of the second chamber region 26 may be provided in the second chamber region 26. The region partition wall 70 may divide the second chamber region 26 into different chamber region portions, wherein the several second outlet channels 16a, 16b open into different ones of the chamber region portions. It is thus possible to transfer separate partial volumes of the second liquid volume out of the fluid chamber 12 through the several second outlet channels 16a, 16b.

In the above examples, the first outlet structure has a first outlet channel in each case. The second outlet structure is provided with one outlet channel in each of the examples shown in FIGS. 1 to 3 and is provided with two outlet channels in the embodiment shown in FIG. 4. In other examples, the first and second outlet structures may have a different number of outlet channels, with the above explanations regarding the outlet channels 16a and 16b applying analogously in each case.

In examples, the fluidic resistance R2 of the second outlet structure and the fluidic resistance R1 of the first outlet structure have such a ratio that a pressure build-up required for a transfer of the first liquid through the first outlet structure is possible, even if the second outlet structure, or the outlet channels thereof, are not filled with a liquid but with a gas. In such examples, the resistance ratio R2/R1 is at least a factor of 30 when filled with the same fluid. Mathematically, the resistance ratio may be expressed as: R2/R1=Cg2*I2/A2²/(Cg1*I1/A1², where Cg1 and Cg2 are constants known to those skilled in the art and depend on the duct cross-section, I1 and I2 are the lengths of the first and second outlet channels, and A1 and A2 are the cross-sectional areas of the first and second outlet channels.

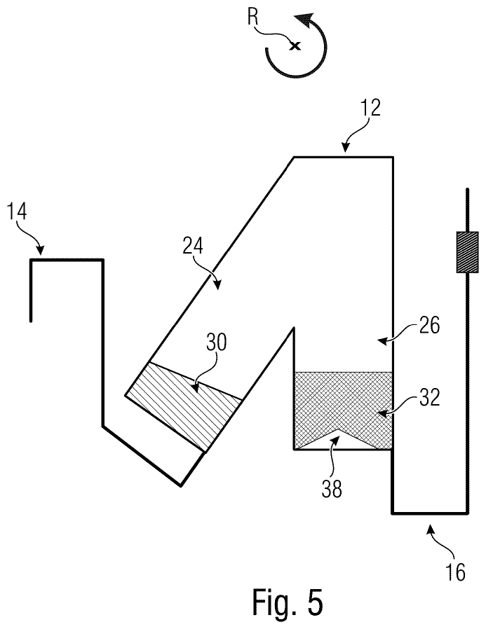

In examples, the fluidic module is provided with fluidic structures configured to support the generation of positive pressure required to transfer the first liquid volume by at least partially filling the outlet channel(s) of the second outlet structure with liquid during this transfer. Corresponding examples are described below with reference to FIGS. 5 to 8. The fluidic structures can ensure that once the second liquid has been transferred through the second outlet structure, it is possible to refill the second outlet channel(s). Due to the higher viscosity of the liquid compared to the gas, e.g. air, by a factor of approximately 50, it can thus be ensured that the fluidic resistance 36 is higher by a factor of approximately 50 than when the second outlet channel is filled with gas.

FIG. 5 shows an example in which a projection 38, which is configured radially inwards and may also be referred to as a partition wall, is integrated into the chamber region 26, which prevents the entire liquid volume 32 from being transferred. By correspondingly accelerating or decelerating the fluidic module after the transfer of the liquid volume 32, forces can be generated to flush this projection and thus enable the second outlet channel to be filled again. In examples, the fluid handling device may be configured to effect an acceleration or deceleration that causes such a flush to occur so that the part of the second liquid volume remaining in the chamber region 26 enters the second outlet channel 16.

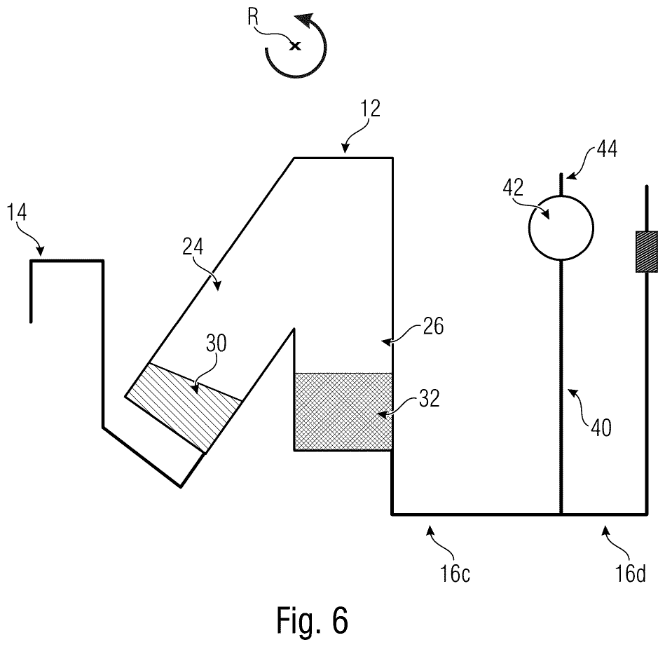

FIG. 6 shows an additional chamber 42, which is connected to the outlet channel 16c, 16d via a channel 40. The chamber 42 may be configured as a compression chamber, but may also be connected to the rest of the fluidics or the environment (i.e. vented) via a further channel 44. During the transfer of the liquid volume 32 through the outlet channel 16c, 16d, a part of the second liquid volume is transported into the chamber 42 according to the resistance ratio of the channels 16d and 40. After the liquid volume 32 has been completely transferred out of the chamber 12 by the positive pressure in this chamber and the positive pressure has been reduced through the channels 40 and 16d, the volume transferred into the chamber 42 is conveyed back into the outlet channels 16c and 16d by centrifugal force. In alternative examples, the chamber 42 may also be configured merely as a channel expansion of the outlet channel 16c, 16d. Since liquid is temporarily stored in the chamber 42, for example between the transfer of the second liquid volume and the transfer of the first liquid volume, it may also be referred to as an intermediate chamber.

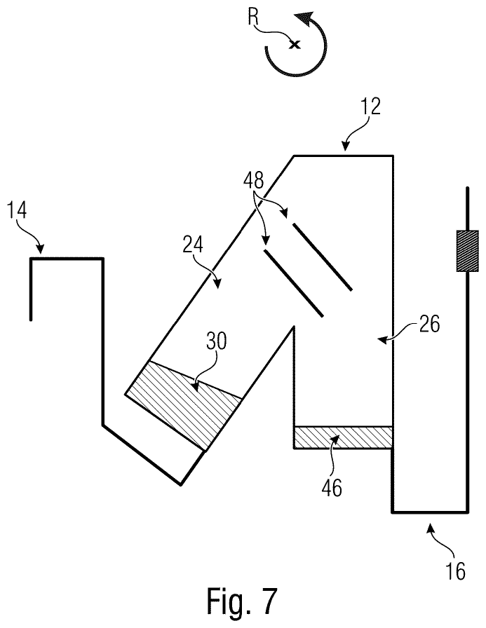

FIG. 7 shows an example in which, after the transfer of the second liquid volume by reheating the chamber 12, a part of the first liquid volume 30 vaporises, condenses on the chamber walls and is then conveyed into the sub-chamber 26 by centrifugation. From there, the liquid flows into the second outlet channel to fill it at least partially. In such an example, structures may be provided in the chamber or chamber wall (48) that allow a majority of the condensed liquid to stream into the sub-chamber 26.

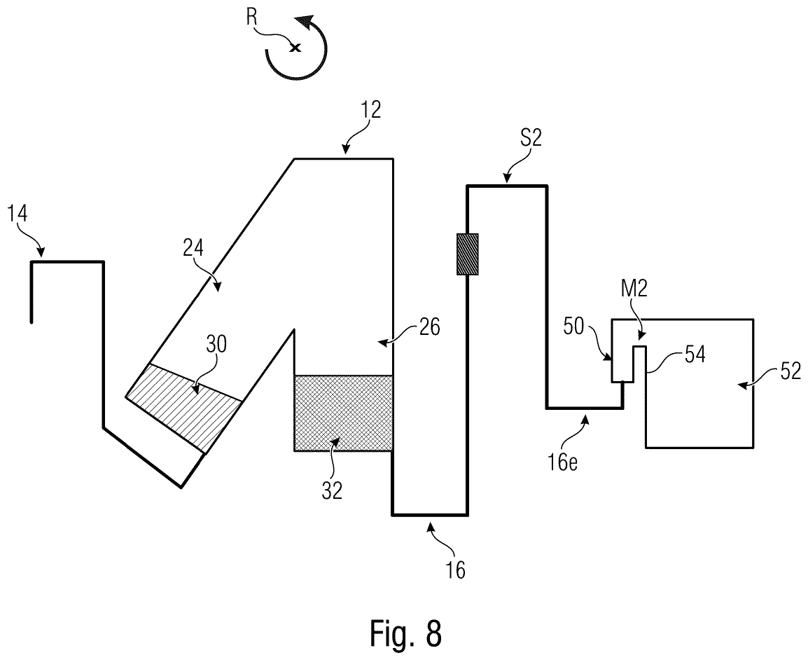

FIG. 8 shows an example in which the connection between the outlet channel 16 and a subsequent chamber 52 is configured such that a part of the transferred liquid volume 32 does not enter the subsequent chamber 52, but remains in a chamber region 50 into which the outlet channel 16 opens. The chamber regions 52 and 50 are separated from one other by a barrier 54 that rises radially inwards. After the transfer of the liquid volume 32, the liquid volume remaining in the chamber region 50 can be returned to the outlet channel 16 by centrifugation. In examples, the position M2, which is defined by the radially inner end of the barrier 54, may be radially further inwards than the radial position of the siphon S2. In examples, the position M2 may be radially further out than the radial position of the siphon S2. Depending on the position of these two positions, either areas of the entire channel 16 or only an area 16e are filled.

In the examples described above, the pressurising device is provided with a heating device. In alternative examples, the pressurising device may be configured to chemically generate a positive pressure in the chamber. For example, a gas bubble reactor may be used in the fluid chamber to generate a positive pressure in the fluid chamber. A reaction substance may be arranged in the fluid chamber which, for example, causes a gas generation reaction when it comes into contact with a liquid. The reactant (catalyst) may be provided on wall portions of the fluid chamber. For example, the following reactions may be utilised by running them in a chamber of the fluidic module. Positive pressure may be generated by producing oxygen, for example via hydrogen peroxide, which is converted into water and oxygen using a catalyst such as manganese dioxide. Pressurisation may also be achieved by generating nitrogen, for example by converting ammonium nitrate into water, oxygen and nitrogen. Pressure may also be generated via a carbon dioxide generation, for example by means of calcium carbonate which reacts with hydrogen chloride to form calcium chloride, water and carbon dioxide. In other examples, pressure may be generated by producing hydrogen; e.g. magnesium and water react to form magnesium hydroxide and hydrogen. Another possibility is the electrochemical generation of gas. Electrolysis may be used to split water into hydrogen and oxygen, for example. The corresponding pressure may be generated in the fluid chamber or in structures fluidically connected to the fluid chamber, as long as it is ensured that the required positive pressure can be generated in the fluid chamber.

Thus, examples of the present disclosure provide devices and methods that enable different fluid volumes to be transferred from a fluid chamber independently of one another. In examples, two stick packs may be arranged in the fluid chamber, which are opened in the course of an automation process by means of centrifugal force and temperature input and the liquid contained therein is pumped out of the fluid chamber. This makes it possible to transfer liquid from two stick packs to different downstream fluidic structures in a space-saving and simple way using just one fluid chamber. This enables the corresponding handling of liquids with a smaller footprint and lower demands on the analyser. For example, compared to a case in which two stick pack chambers are provided on one cartridge, only one heating zone is required instead of two heating zones.

The above embodiments comprise two chamber regions that allow liquids to be pre-stored separately from one another. In alternative embodiments, a larger number of chamber regions may be provided, each with associated outlet channels.

Examples of the present disclosure provide a fluidic module rotatable about a centre of rotation, provided with a fluid chamber and two to N outlet channels, wherein in the fluid chamber at least two liquids can be pre-stored geometrically separated by centrifugal force, wherein in the chamber at least two liquids are connected via a common air volume, wherein the liquids can be maintained in the fluid chamber by hydrostatic pressure by rotation, wherein a first channel and at least one second channel have different outflow barriers with respect to the hydrostatic height, i.e. different radial positions of the highest point of the siphon, wherein the channels can have decreasing fluidic resistances with a rising outflow barrier, and wherein the positive pressure in the fluid chamber can be chemically or physically controlled. In examples of such a fluidic module, the temperature of the liquid and the air in the fluid chamber may be adjusted by a heating element in order to control the pressure in the fluid chamber. In examples, a structure adjacent to the channel with the lowest outflow barrier may be vented via a channel. In examples, a structure adjacent to the channel with the lowest outflow barrier may become a compression chamber during transport. In examples, the liquids may be the same liquid or different liquids. In examples, the liquid volumes in the chamber portions may be distributed in a defined manner via geometric structures and/or an overflow structure in the fluid chamber. In examples, the fluid chamber may be vented through a channel with high fluidic resistance. In examples, several second outlet channels may have different resistances. In examples, a heating element may be provided to create the positive pressure, wherein the heating element may be configured to adjust the temperature locally, only for the chamber, or globally, for the entire fluidic module.

In general, the outlet structures may be configured in such a way that after transferring the second liquid, a positive pressure can be generated and maintained in the fluid chamber such that the first liquid volume can also be transferred through the first outlet structure. This may be achieved by a correspondingly higher fluidic resistance, for example at least 50 times higher fluidic resistance of the second outlet structure, so that even if the second outlet structure is filled with a gas, e.g. air, venting takes place so slowly that the positive pressure is sufficient to transfer the first liquid volume. In examples in which liquid is disposed in at least parts of the second outlet structure during transfer of the first liquid volume through the first outlet structure, the resistance ratio between the second outlet structure and the first outlet structure may be significantly lower and, for example, in a range of 5 to 10. Although liquid is then transferred through both outlet structures, it is transferred faster through the first outlet structure than through the second outlet structure, so that the first liquid volume can be transferred through the first outlet structure before the liquid in the second chamber region has completely passed through the second outlet structure. In general, the fluidic module may therefore be configured in such a way that when transferring the first liquid through the first outlet structure, a volume flow through the first outlet structure is greater than a volume flow (gas or liquid) through the second outlet structure.

Although features of the invention have been described in each case on the basis of device features or method features, it is obvious to those skilled in the art that corresponding features can also be part of a method or device in each case. Thus, the device may be configured in each case to perform corresponding method steps, and the respective functionality of the device may represent corresponding method steps.

In the preceding detailed description, various features were sometimes grouped together in examples in order to rationalise the disclosure. This type of disclosure is not intended to be interpreted as meaning that the claimed examples have more features than are expressly stated in each claim. Rather, as the following claims disclose, the object may lie in less than all of the features of a single disclosed example. Consequently, the following claims are hereby incorporated into the detailed description, wherein each claim may stand as its own separate example. While each claim may stand as its own separate example, it should be noted that although dependent claims in the claims refer back to a specific combination with one or more other claims, other examples also include a combination of dependent claims with the object of any other dependent claim or a combination of any feature with other dependent or independent claims. Such combinations are included unless it is stated that a specific combination is not intended. It is further intended that a combination of features of a claim with any other independent claim is also encompassed, even if that claim is not directly dependent on the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A fluidic module for use in a centrifugal microfluidic system, comprising:
a fluid chamber with a first chamber region and a second chamber region which are separated from one another by a partition wall which extends radially inwards with respect to a centre of rotation, wherein a first liquid volume in the first chamber region can be pre-stored separately from a second liquid volume in the second chamber region, while a common air volume is arranged radially inside the first and second liquid volumes;
a first outlet structure comprising at least one first outlet channel which opens into the first chamber region and comprises an outflow barrier for a liquid flow from the first chamber region in the form of a radially inwardly rising channel portion which extends to a first radial position; and
a second outlet structure which comprises at least one second outlet channel which opens into the second chamber region and comprises an outflow barrier for a liquid flow from the second chamber region in the form of a radially inwardly rising channel portion which extends to a second radial position,
wherein the first radial position is radially further inwards than the second radial position,
wherein the fluidic module is configured such that, based on a rotation in which a hydrostatic pressure acting on the first and second liquid volumes prevents the liquid volumes from flowing out of the fluid chamber through the first and second outlet structures, a positive pressure in the common air volume required to transfer the first liquid volume out of the fluid chamber through the first outlet structure against the hydrostatic pressure acting on the first liquid volume is greater than a positive pressure in the common air volume required to transfer the second liquid volume out of the fluid chamber through the second outlet structure against the hydrostatic pressure acting on the second liquid volume.

2. The fluidic module according to claim 1, wherein the fluidic resistance of the second outlet structure for a fluid flow out of the fluid chamber is greater than the fluidic resistance of the first outlet structure for a fluid flow out of the fluid chamber.

3. The fluidic module according to claim 1, wherein the second outlet structure comprises several second outlet channels opening into the second chamber region, wherein the total fluidic resistance of the several second outlet channels for a fluid flow out of the fluid chamber is greater than the fluidic resistance of the first outlet structure for a fluid flow out of the fluid chamber.

4. The fluidic module according to claim 3, wherein the second chamber region is separated into several chamber region portions by at least one radially inwardly extending region partition wall, wherein one of the several second outlet channels opens into each of the chamber region portions.

5. The fluidic module according to claim 1, wherein the first outlet channel comprises a first inverse siphon channel, wherein the first radial position is formed by an apex of the first inverse siphon channel, and/or wherein the second outlet channel comprises a second inverse siphon channel, wherein the second radial position is formed by the apex of the second inverse siphon channel.

6. The fluidic module according to claim 1, further comprising a vent channel connecting the fluid chamber to further fluidic structures of the fluidic module or the outside, the vent channel comprising a vent resistance enabling it to create a positive pressure in the fluid chamber sufficient to transfer the second liquid volume out of the fluid chamber through the second outlet structure.

7. The fluidic module according to claim 1, wherein a ratio of the fluidic resistance of the second outlet structure to the fluidic resistance of the first outlet structure when filled with the same fluid is at least a factor of 30, preferably a factor of at least 50.

8. The fluidic module according to claim 1, wherein fluidic structures of the fluidic module are configured to allow, subsequent to the transfer of liquid of the second liquid volume through the second outlet structure, the second outlet structure to remain or become at least partially filled with liquid.

9. The fluidic module according to claim 8, wherein the fluidic structures include a radially inwardly extending projection in an outer chamber wall of the second chamber region, said inwardly extending projection being configured to retain a portion of the liquid of the second liquid volume in the second chamber region upon transfer of the liquid of the second liquid volume through the second outlet structure and to subsequently be swept by changing the rotational frequency so that liquid enters the second outlet structure.

10. The fluidic module according to claim 8, wherein the fluidic structures include an intermediate chamber disposed in or fluidly coupled to the second outlet structure and configured to be filled with liquid of the second liquid volume upon transfer of liquid of the second liquid volume through the second outlet structure, and to at least partially fill the one or more second outlet channels with the liquid after the transfer.

11. The fluidic module according to claim 8, wherein the fluidic structures include an orifice of the one or more second outlet channels into a downstream fluid chamber, configured to retain or return a portion of the fluid of the second liquid volume into the second outlet channel or the second outlet channels after transfer through the second outlet structure.

12. The fluidic module according to claim 8 wherein the fluidic structures include chamber walls of the fluid chamber which are configured in such a way that liquid of the first liquid volume which evaporates by heating and condenses on the chamber walls is at least partially guided into the second chamber region by centrifugation and at least partially fills the one or several second outlet channels there.

13. Fluid handling device, comprising:
a fluidic module according to claim 1;
a drive device which is configured to impart rotation to the fluidic module;
a pressurising device for generating a positive pressure in the common air volume of the fluidic module; and
a control device which is configured
to control the drive device to impart the rotation to the fluidic module, at which the first and second liquid volumes are held in the fluid chamber by the acting hydrostatic pressure,
to control the pressurising device to generate, from said rotation, a positive pressure in the common air volume sufficient to transfer the second liquid volume out of the fluid chamber against the hydrostatic pressure through the second outlet structure.

14. The fluid handling device according to claim 13, wherein the pressurising device comprises a heating device configured to heat the common air volume in the fluid chamber to generate the positive pressure.

15. The fluid handling device according to claim 13, wherein the control device is configured to reduce a rotational speed of the rotation of the fluidic module to at least assist a transfer of the first liquid volume through the first outlet structure from the fluid chamber.

16. The fluid handling device according to claim 15, wherein the control device is configured to control the drive device, after transferring the second liquid volume through the second outlet structure, to reduce the rotational speed of the rotation of the fluidic module and thus the hydrostatic pressure acting on the first liquid volume so that the positive pressure in the air volume in the fluid chamber is sufficient to transfer the first liquid volume out of the fluid chamber against the hydrostatic pressure through the first outlet structure.

17. The fluid handling device according to claim 13, wherein the control device is configured to control the pressurising device, after transferring the second liquid volume through the second outlet structure and after reducing the positive pressure in the air volume in the fluid chamber, to generate a positive pressure in the air volume in the fluid chamber sufficient to transfer the first liquid volume out of the fluid chamber against the hydrostatic pressure through the first outlet structure.

18. The fluid handling device according to claim 17, wherein the pressurising device comprises one or the heating device, wherein the control device is configured to switch off the heating device after transferring the second liquid volume through the second outlet structure, thereby cooling the air volume in the fluid chamber, and to control the heating device, after cooling the air volume in the fluid chamber and reducing a resulting negative pressure in the air volume in the fluid chamber, to heat the air volume in the fluid chamber to create a positive pressure in the air volume in the fluid chamber sufficient to transfer the first liquid volume out of the fluid chamber against the hydrostatic pressure through the first outlet structure.

19. Method for transferring a first liquid volume from a first chamber region of a fluid chamber through a first outlet structure comprising a first outlet channel, and a second liquid volume from a second chamber region of the fluid chamber through a second outlet structure comprising a second outlet channel, wherein the first chamber region and the second chamber region are separated by a partition wall extending radially inwardly with respect to a centre of rotation, wherein a common air volume is arranged radially within the first and second liquid volumes, wherein the first outlet channel opens into the first chamber region and an outflow barrier in the form of a radially inwardly rising channel portion is provided for a liquid flow from the first chamber region, which extends to a first radial position, wherein the second outlet channel opens into the second chamber region and comprises an outflow barrier in the form of a radially inwardly rising channel portion for a flow of liquid from the second chamber region, which extends to a second radial position, wherein the first radial position is located radially further inwards than the second radial position, such that, starting from a rotation in which a hydrostatic pressure acting on the first and second liquid volumes prevents the liquid volumes from flowing out of the fluid chamber through the first and second outlet structures, respectively, a positive pressure in the common air volume required to transfer the first liquid volume out of the fluid chamber through the first outlet structure against the hydrostatic pressure acting on the first liquid volume is greater than a positive pressure in the common air volume required to transfer the second liquid volume out of the fluid chamber through the second outlet structure against the hydrostatic pressure acting on the second liquid volume, with the following features:
imparting a rotation to the fluidic module, at which the first and second liquid volumes are held in the fluid chamber by the acting hydrostatic pressure,
based on said rotation, creating a positive pressure in the common air volume sufficient to transfer the second liquid volume out of the fluid chamber against the hydrostatic pressure through the second outlet structure, and
transferring the first liquid volume through the first outlet structure out of the fluid chamber by generating a ratio of the hydrostatic pressure acting on the first liquid volume and the positive pressure in the fluid chamber, at which the first liquid volume is transferred through the first outlet structure out of the fluid chamber.

20. The method according to claim 19, wherein the generated positive pressure sufficient to transfer the second liquid volume out of the fluid chamber against the hydrostatic pressure through the second outlet structure is insufficient to transfer the first liquid volume out of the fluid chamber against the hydrostatic pressure through the first outlet structure.

21. The method according to claim 19, wherein generating the positive pressure sufficient to transfer the second liquid volume out of the fluid chamber against the hydrostatic pressure through the second outlet structure comprises heating the common air volume in the fluid chamber.

22. The method according to claim 19, which comprises reducing a rotational speed of the rotation of the fluidic module to at least assist a transfer of the first liquid volume through the first outlet structure from the fluid chamber.

23. The method according to claim 22, which comprises, after transferring the second liquid volume through the second outlet structure, reducing the rotational speed of the rotation of the fluidic module to reduce the hydrostatic pressure acting on the first liquid volume such that the positive pressure in the air volume in the fluid chamber is sufficient to transfer the first liquid volume out of the fluid chamber against the hydrostatic pressure through the first outlet structure.

24. The method according to claim 19, which comprises, after transferring the second liquid volume through the second outlet structure and after reducing the positive pressure in the air volume in the fluid chamber, generating a positive pressure in the air volume in the fluid chamber sufficient to transfer the first liquid volume out of the fluid chamber against the hydrostatic pressure through the first outlet structure.

25. The method according to claim 24, which comprises, after transferring the second liquid volume through the second outlet structure, switching off a heating device to cool the air volume in the fluid chamber, and subsequently, after reducing a negative pressure in the air volume in the fluid chamber caused by the cooling, heating the air volume in the fluid chamber to create a positive pressure in the air volume sufficient to transfer the first liquid volume out of the fluid chamber against the hydrostatic pressure through the first outlet structure.

26. The method according to claim 19, wherein subsequent to transferring the second liquid volume through the second outlet structure, the second outlet structure remains or becomes at least partially filled with liquid, such that the fluidic resistance of the second outlet structure during transfer of the first liquid volume through the first outlet structure is determined by the viscosity of the liquid in the second outlet structure.
